(19) United States
(12) Patent Application Publication
(10) Pub. No.: US 2016/0102775 A1
(43) Pub. Date: Apr. 14, 2016

(54) FLOW CONTROL SYSTEM AND METHOD

(71) Applicant: Fadi SHAKKOUR, HAWTHORNE, CA (US)

(72) Inventor: Fadi SHAKKOUR, HAWTHORNE, CA (US)

(21) Appl. No.: 14/512,373

(22) Filed: Oct. 10, 2014

(51) Int. Cl. F16K 31/04; F16K 31/06

(52) U.S. Cl. CPC F16K 31/047; F16K 31/0675

(57) ABSTRACT

The present invention discloses an electrical actuator, comprising an electrical device and a drive train detachably associated with the electrical device for transmission of power for driving a detachably coupled external equipment.

### BACKGROUND OF THE INVENTION

1. Field of the Invention

One or more embodiments of the present invention relate to flow control system and method for controlling flow of fluids and more particularly, a flow control system and method using an electrical actuator.

2. Description of Related Art

Electrically actuated equipments such as valves for control of flow of fluids are well known and have been in use for a number of years. In general, an electric actuator is a device that is powered electrically for converting electrical energy to mechanical torque. The electrical energy is used to actuate (move, or control) equipment such as valves. Major drawbacks with the conventional electrically actuated equipment are that they are complex, not efficient and further, slow to actuate (from open to close or close to open positions).

Accordingly, in light of the current state of the art and the drawbacks to current electrically actuated equipment mentioned above, a need exists for an electrically actuated device that would be simple, compact, reliable, would generate sufficient torque to efficiently (e.g., speedily, less energy use, etc.) actuate equipment, and would be easily serviced.

### BRIEF SUMMARY OF THE INVENTION

A non-limiting, exemplary aspect of an embodiment of the present invention provides an electric device, comprising:

a first mode of operation with no power supplied to the electric device;

a first phase of a second mode of operation with power supplied to the electric device; and

a second phase of the second mode of operation with power supplied to a biasing mechanism of the electric device, only.

Another non-limiting, exemplary aspect of an embodiment of the present invention provides an electric device, comprising:

a motor;

a first biasing mechanism for biasing a rotor assembly of the motor to a first axial position in a first mode of operation of the electric device; and

a second biasing mechanism for holding the rotor assembly of the motor in a second axial position in a second mode of operation of the electric device.

Still another non-limiting, exemplary aspect of an embodiment of the present invention provides a control circuit, comprising:

a power source coupled with a first electromagnetic device and a second electromagnetic device; and

an isolator that isolates one of a first or second electromagnetic device during one of a first or a second mode of operations of one of the first or second electromagnetic device.

Yet another non-limiting, exemplary aspect of an embodiment of the present invention provides a control circuit, comprising:

a switch that is series connected with a motor, with the combine series connected motor and switch connected between a power line and neutral;

a solenoid that is coupled in parallel with the combined series connected motor and switch, with the switch in an open condition isolating the motor from the power source while power is continuously supplied to the solenoid.

Another non-limiting, exemplary aspect of an embodiment of the present invention provides an electrical actuator, comprising:

an electrical device; and

a drive train detachably associated with the electrical device for transmission of power for driving a detachably coupled external equipment.

Another non-limiting, exemplary aspect of an embodiment of the present invention provides a valve assembly, comprising:

a valve housing that includes a valve mechanism that controls inflow of fluid from an inlet port for a controlled outflow of fluid to an outlet port;

the valve housing defines an axis of rotation for a valve stem that pivots about the axis of rotation for opening and closing the valve mechanism.

Yet another non-limiting, exemplary aspect of an embodiment of the present invention provides a flow control system, comprising:

a valve system; and

an electrical actuator associated with the valve system by a mounting brace.

Such stated advantages of the invention are only examples and should not be construed as limiting the present invention. These and other features, aspects, and advantages of the invention will be apparent to those skilled in the art from the following detailed description of preferred non-limiting exemplary embodiments, taken together with the drawings and the claims that follow.

### BRIEF DESCRIPTION OF THE DRAWINGS

It is to be understood that the drawings are to be used for the purposes of exemplary illustration only and not as a definition of the limits of the invention. Throughout the disclosure, the word “exemplary” may be used to mean “serving as an example, instance, or illustration,” but the absence of the term “exemplary” does not denote a limiting embodiment. Any embodiment described as “exemplary” is not necessarily to be construed as preferred or advantageous over other embodiments. In the drawings, like reference character(s) present corresponding part(s) throughout.

FIG. 1 is a non-limiting, exemplary illustration of a flow control system in accordance with one or more embodiments of the present invention;

FIGS. 2A to 2C are non-limiting, exemplary illustrations of various open views of the flow control system shown in FIG. 1 in accordance with one or more embodiments, with FIGS. 2A and 2C showing an isometric open view that illustrate the various components of the flow control system, and FIG. 2B is a partial sectional view taken from FIG. 1;

FIG. 3 is a non-limiting, exemplary illustration of a fluid circuit adaptor in accordance with one or more embodiments of the present invention;

FIG. 4 is a non-limiting, exemplary illustration of a valve housing of a valve assembly in accordance with one or more embodiments of the present invention;

FIGS. 5A to 5H are non-limiting, exemplary illustrations of a mounting brace in accordance with one or more embodiments of the present invention;

FIGS. 6A to 6E are non-limiting, exemplary detailed illustrations of an electrical device, including electromechanical components and operations thereof through various modes and phases of operation of flow control system in accordance with one or more embodiments of the present invention;

FIG. 7A is non-limiting, exemplary electrical schematic illustration for a flow control system, showing a cycle of various modes and phases of operation in accordance with one or more embodiments of the present invention;

FIGS. 7B to 7D are non-limiting, exemplary illustrations of progressive movement of a switch actuator in accordance with one or more embodiments of the present invention; and

FIGS. 8A to 8F are non-limiting, exemplary illustrations of a flow control system in accordance with one or more embodiments of the present invention where a location of a manual lever and valve system are switched.

### DETAILED DESCRIPTION OF THE INVENTION

The detailed description set forth below in connection with the appended drawings is intended as a description of presently preferred embodiments of the invention and is not intended to represent the only forms in which the present invention may be constructed and or utilized.

Throughout the disclosure, the term fluid may be construed as any substance or material that has no fixed shape and yields to external pressures. Non-limiting examples of fluids may include liquids, gases, fluidized solids (slurries), etc., or combinations thereof.

One or more embodiments of the present invention provide a flow control system and method using an electrically actuated device that is simple, compact, and reliable, and that generates sufficient torque to efficiently (e.g., speedily, less energy use, etc.) actuate equipment such as a valve system, and is easily serviced.

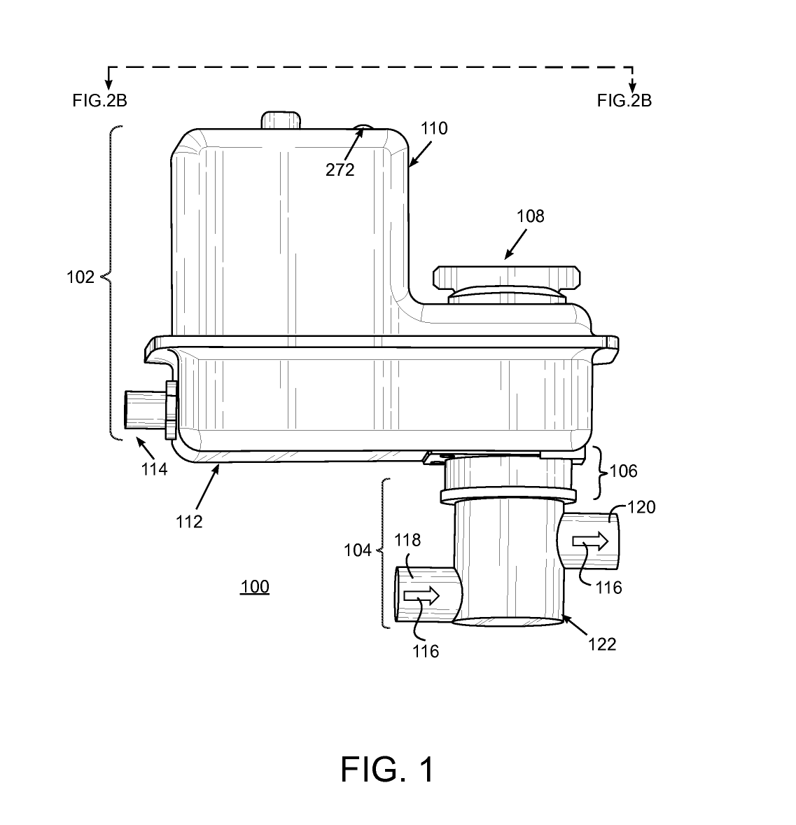

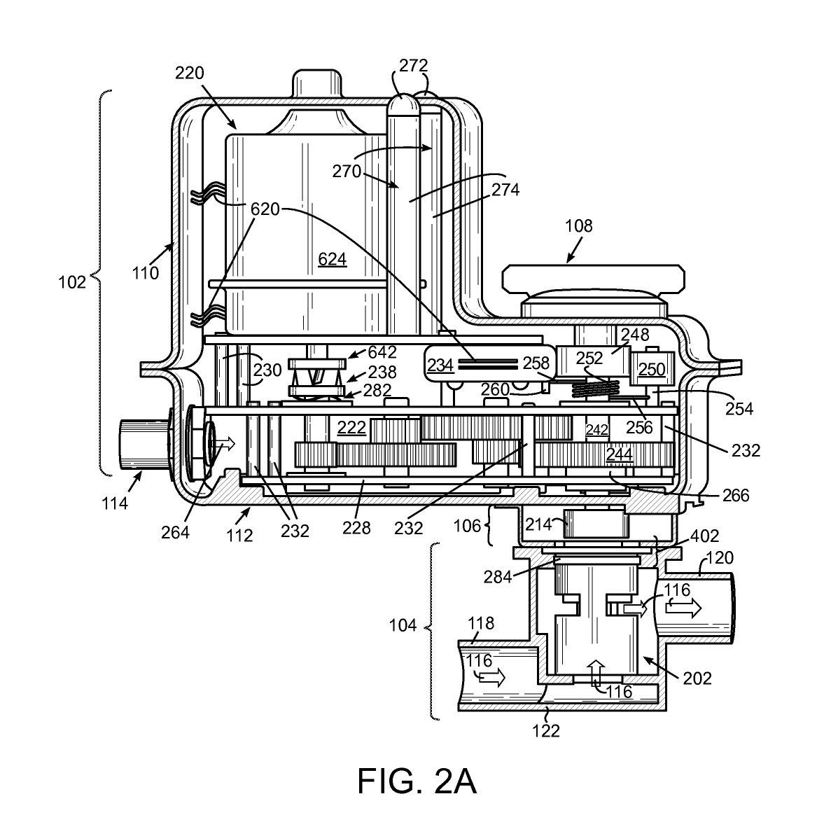

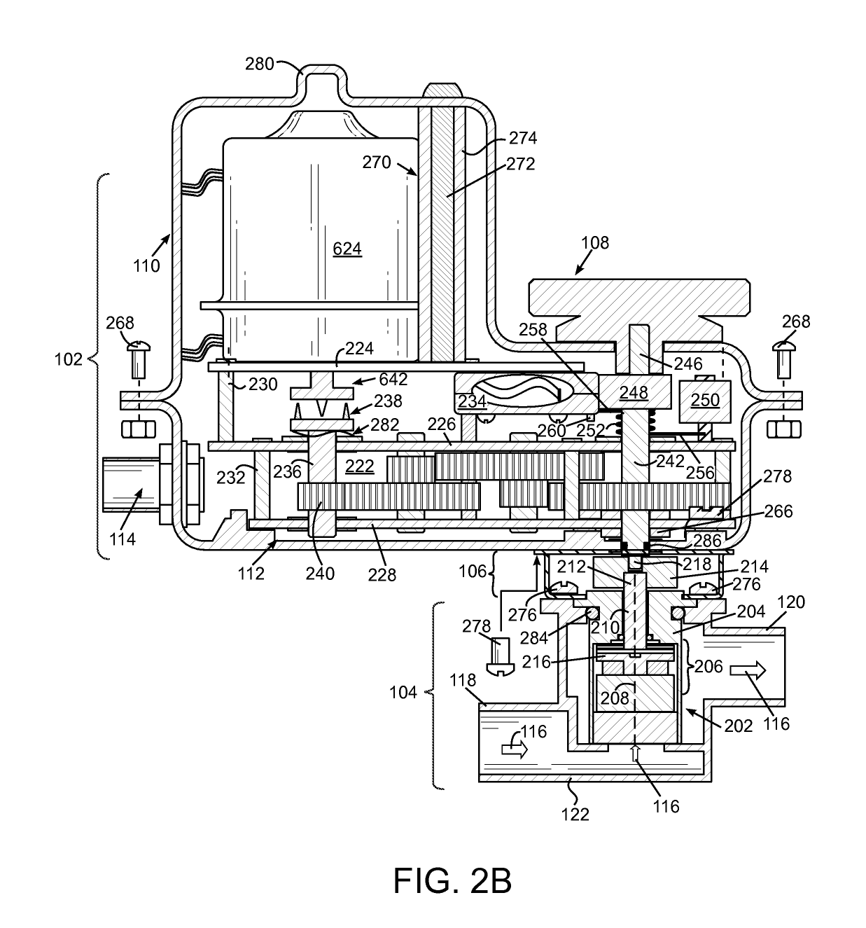

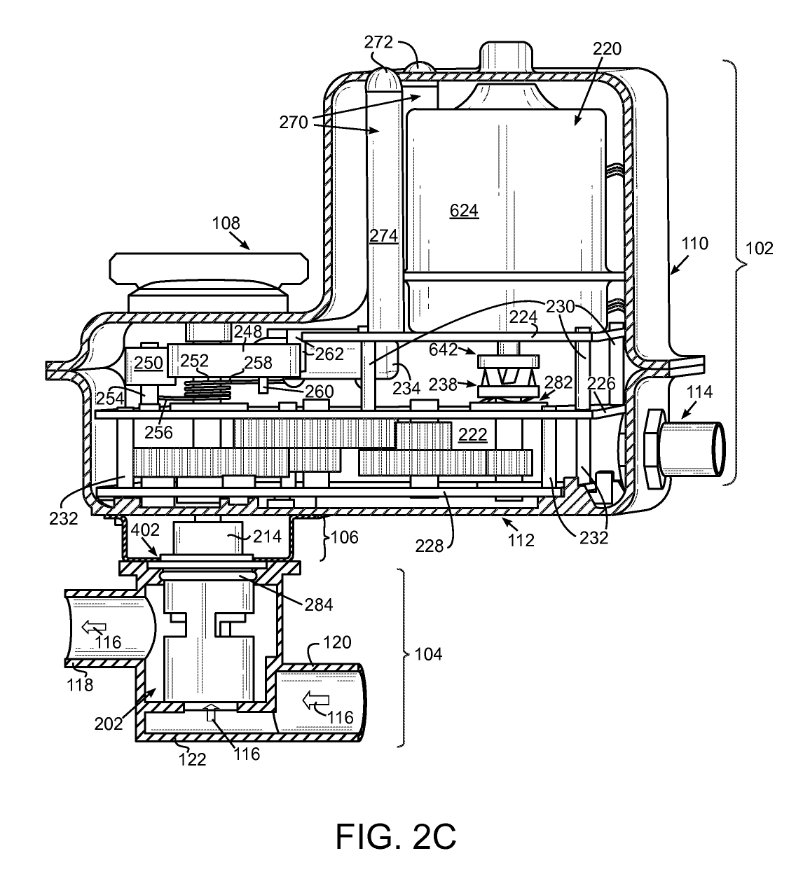

FIG. 1 is a non-limiting, exemplary illustration of a flow control system in accordance with one or more embodiments of the present invention. As illustrated in FIG. 1, a flow control system 100 is provided that includes an electrical actuator 102 associated with a valve system 104 by a mounting brace 106. Valve system 104 includes a valve assembly 202 (FIG. 2A) associated with a fluid circuit adaptor 122 that is interposed in a fluid circuit (not shown). Electrical actuator 102 is accommodated within a two-piece housing 110 and 112 that include a power port 114 (a well known threaded bore) for receiving electrical power cables 264, which is represented by the illustrated arrow (FIG. 2A). Valve system 104 under the control of electrical actuator 102 (or manual lever 108, detailed below) enables a controlled flow of fluid 116 from the fluid circuit and into an exemplary inlet port 118 of fluid circuit adaptor 122, through valve assembly 202, and out of an exemplary outlet port 120.

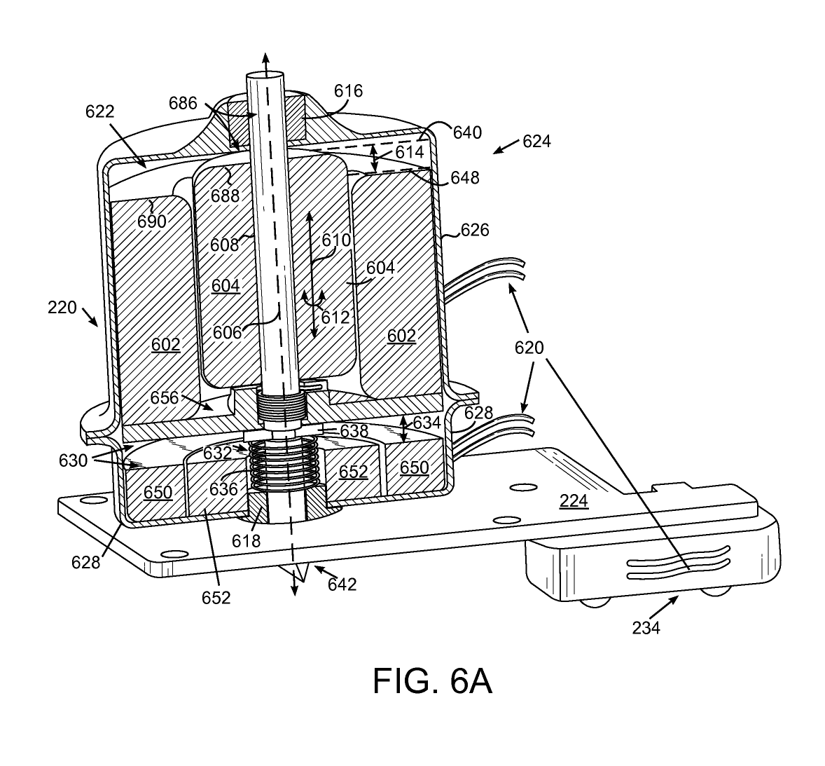

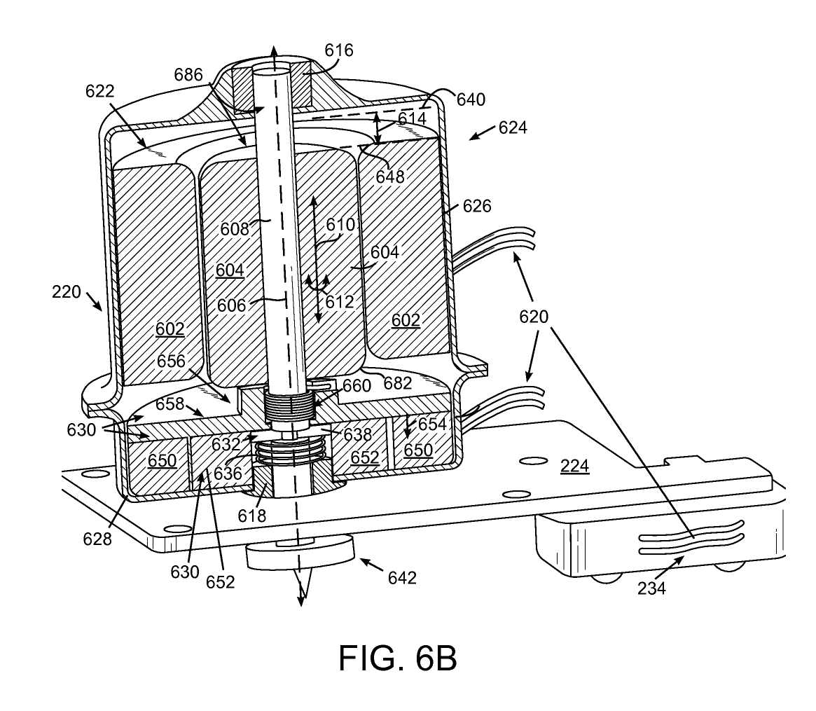

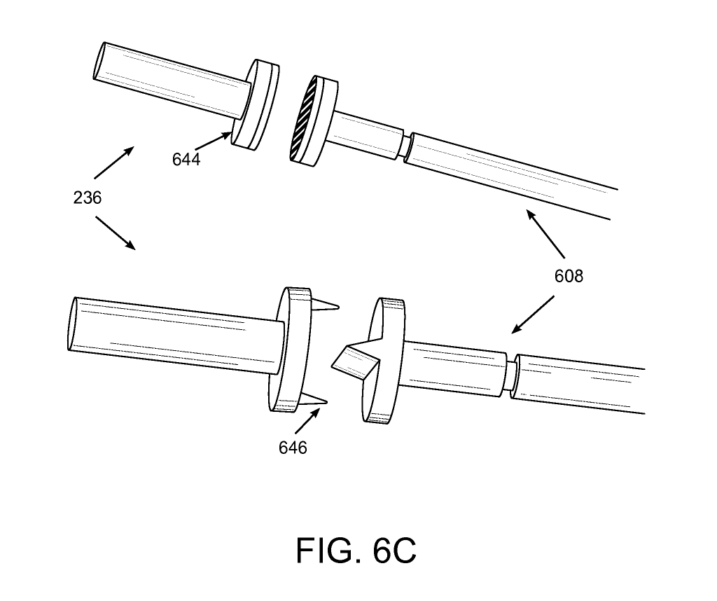

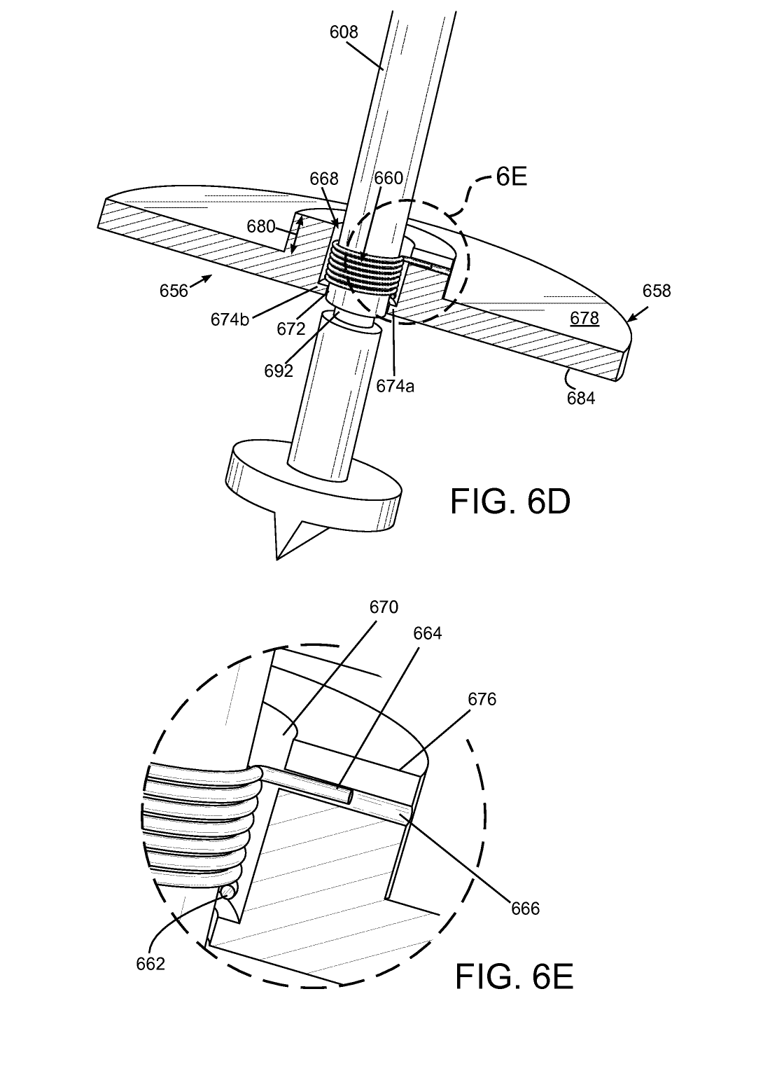

FIGS. 2A to 2C are non-limiting, exemplary illustrations of cut-away or open views of the flow control system shown in FIG. 1 in accordance with one or more embodiments. As illustrated in FIGS. 2A to 2C, in this non-limiting, exemplary instance, piece 110 of the housing may be coupled with second piece 112 of the housing by a set of fasteners 268. Alternatively, first piece 110 and second piece 112 of the housing need not be directly fastened together, but may be coupled with one another through shelves 224 and 228. That is, first piece 110 may be coupled with a first shelf 224 and second piece 112 coupled with a third shelf 228, with first and third shelves 224 and 228 connected to each other as detailed below. For example, first piece 110 may be coupled with first shelf 224 by a set of fastener assembly 270 comprised of a hollow conduit support 274 that includes a fastener 272. In this non-limiting, exemplary instance, first piece 110 may include a set of holes at a top section thereof that receive fasteners 272 and are inserted through hollow conduit support 274. The ends of fasteners 272 are fastened to first shelf 224 while the fastener head is secured to the top section of first piece 110. The reason for the conduit support 274 is to prevent first piece 110 from collapsing onto itself due to the compression force of fastener 272 experienced by first piece 110 in cases where fasteners 272 are tightened too much. Second piece 112 may be simply directly fastened to third shelf 228 in any well-known manner. For example, second piece 112 may include protrusions that may be inserted (or snapped into) a set of correspondingly aligned receiving holes or recesses of the third shelf 228, which may further receive fasteners that secure and connect second piece 112 with third shelf 228. Accordingly, any well-known manner or method may be used to form an enclosure and couple first piece 110 and second piece 112. It should be noted that the first piece 110 includes a protruded portion 280 that allows sufficient room for a rotor shaft 608 to extend out of a motor casing 624 (as detailed below and best shown in FIG. 6A).

As further illustrated in FIGS. 2A to 2C, valve system 104 is comprised of valve assembly 202 that has a valve housing 204 (FIG. 2B) that include a well-known valve mechanism 206 that controls inflow of fluid 116 from inlet port 118 for a controlled outflow of fluid 116 to outlet port 120. Valve housing 204 defines an axis of rotation 208 for a valve stem 210 that pivots about axis of rotation 208 by torque exerted from electrical actuator 102 for opening and closing valve mechanism 206. Valve stem 210 includes a first end 212 that extends out of valve housing 204 and is associated with an actuator coupler 214. Actuator coupler 214 and first end 212 may comprise of single piece or two separate pieces. A second end 216 of valve stem 210 is associated with valve mechanism 206 in well-known conventional manner, which opens or closes valve mechanism 206 for controlled flow of fluid 116.

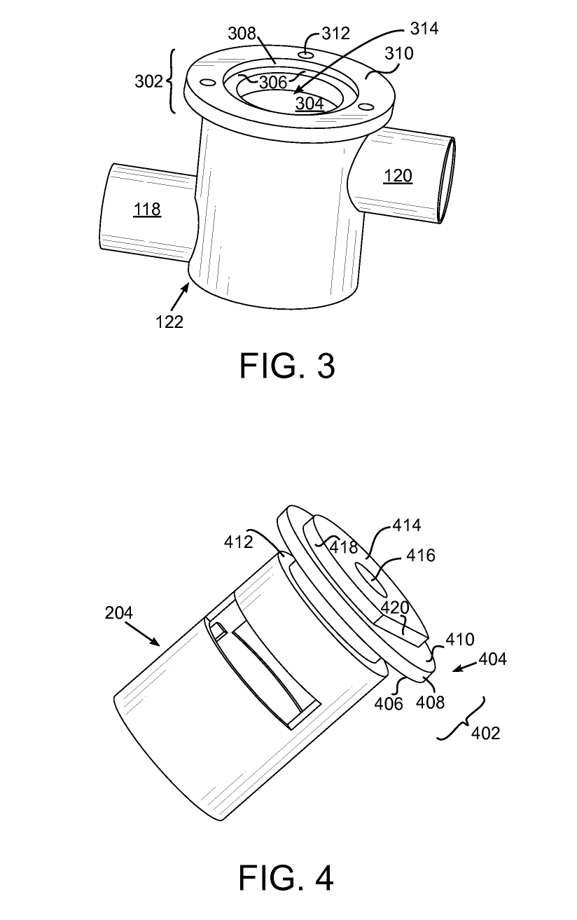

FIG. 3 is a non-limiting, exemplary illustration of a fluid circuit adaptor in accordance with one or more embodiments of the present invention, and FIG. 4 is a non-limiting, exemplary illustration of a valve housing of a valve assembly in accordance with one or more embodiments of the present invention. As illustrated in FIGS. 3 and 4, fluid circuit adaptor 122 in addition to including exemplary inlet and outlet ports 118 and 120 as its lateral openings, it also includes an engagement interface 302 that has an opening 314 that leads into a chamber 304 that receives valve-housing 204 of valve assembly 202. In other words, valve housing 204 is simply inserted through opening 314 of engagement interface 302, and dropped in chamber 304 where a valve engagement interface 402 (FIG. 4) is associated with engagement interface 302 of fluid circuit adaptor 122.

Referring to both FIGS. 3 and 4, valve housing 204 includes valve engagement interface 402 comprised of a flange 404 with a bottom surface 406 that rests on lower edge 306 of chamber 304 of engagement interface 302 of fluid circuit adaptor 122, with flange 404 of valve engagement interface 402 further including a peripheral surface 408 that abuts a raised edge 308 of chamber 304 of engagement interface 302 of fluid circuit adaptor 122. The valve engagement interface 402 further includes a groove 412 that accommodates an O-ring 284 (FIG. 2B), which maintains fluid from leaking out of the fluid circuit adapter 122.

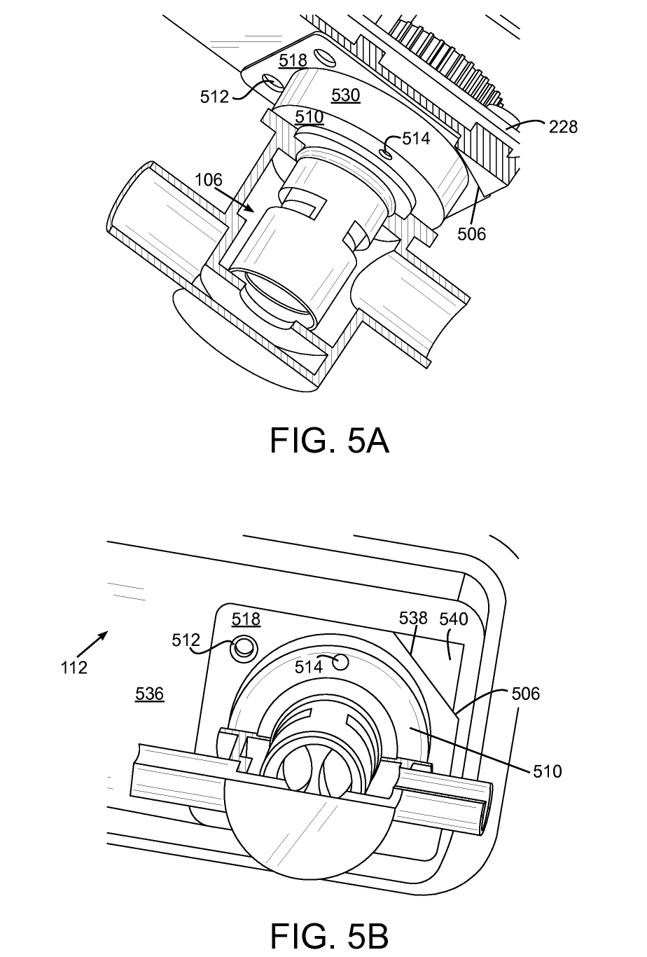

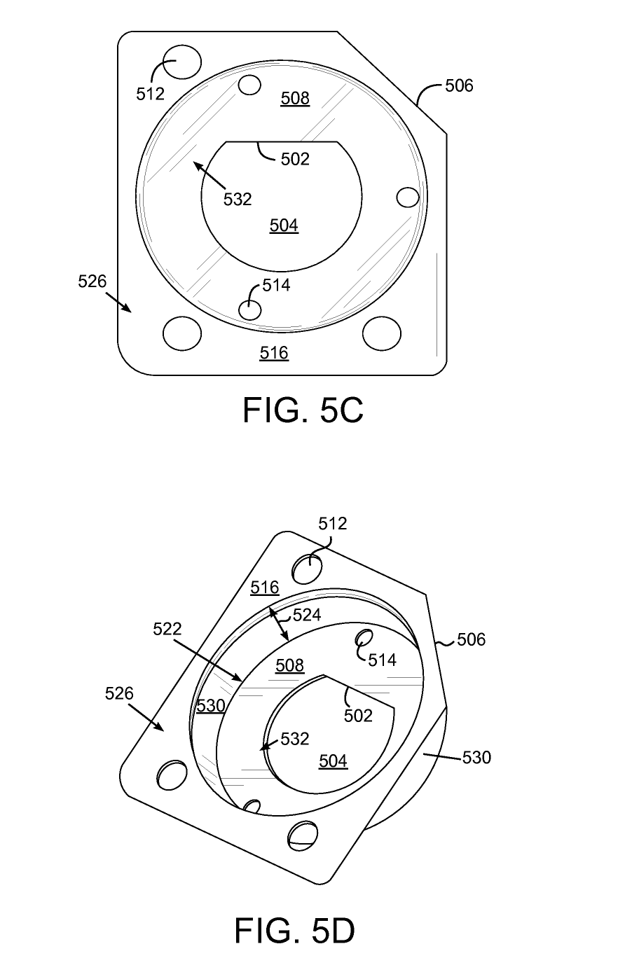

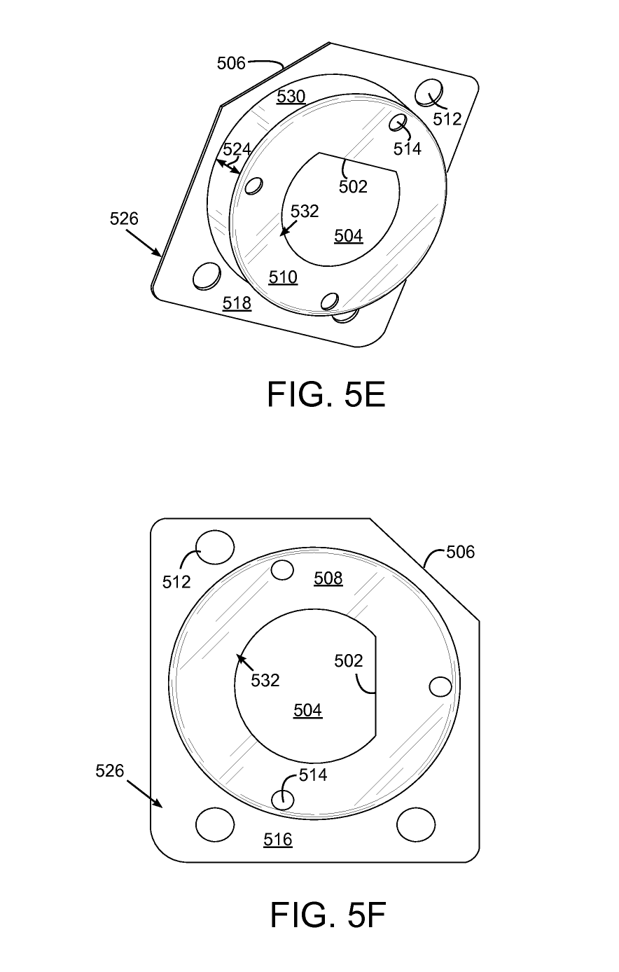

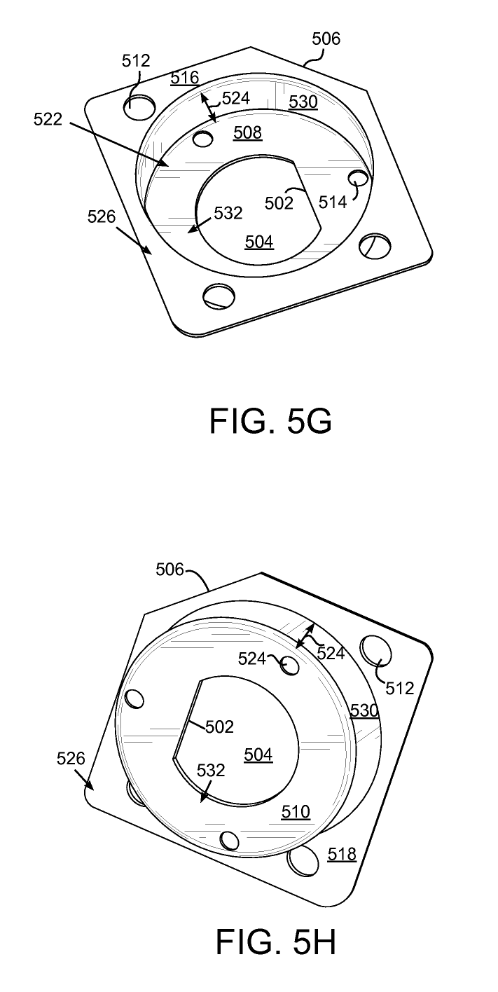

FIGS. 5A to 5H are non-limiting, exemplary illustrations of mounting brace in accordance with one or more embodiments of the present invention. FIGS. 5C to 5E are various views of mounting brace used with normally open flow control system whereas FIGS. 5F to 5H are various view of mounting brace used with a normally closed flow control system. When juxtaposing FIGS. 5C and 5F, it would be readily apparent that the only difference between the two is an orientation of an alignment edge 502 (detailed below).

As illustrated in FIGS. 2B, and 5A to 5H, mounting brace 106 (e.g., a deep drawn enclosure) houses actuator coupler 214 and first end 212 of valve stem 210, in addition to interlocking interface 218 of electrical actuator 102 while securing the electrical actuator 102 with the valve system 104.

Referring to FIGS. 2A to 5H combined, valve engagement interface 402 of valve housing 204 secures valve housing 204 with mounting brace 106 in addition to fluid circuit adaptor 122. Valve engagement interface 402 of valve housing 204 is comprised of a raised portion 414 with an alignment engagement edge 420 for alignment and engagement with an alignment edge 502 of a bottom opening 504 of mounting brace 106 to prevent valve housing 204 from rotation during operation, and allow for easy installation for one of a normally open (FIGS. 5C to 5E) or a normally closed (FIGS. 5F to 5H) operational modes of the valve. Valve assembly 202 has a quarter of a turn (zero to 90 degrees) to open and close and hence, the reason for 90 degree differences in orientation with respect to the interlocking peripheries 420/502 between normally open and normally closed orientations. It should be noted that the peripheries 420/502 may be replaced by other means for securing valve assembly 202 in position and preventing valve assembly 202 from rotation during operation, including use of fasteners or other interlocking or mating features instead. Raised portion 414 of valve housing 204 further includes an opening 416 through which first end 212 of valve stem 210 extends.

As indicated above, valve engagement interface 402 of valve housing 204 is further comprised of flange 404 with bottom surface 406 that rests on ledge 306 of fluid circuit adaptor 122 (via O-ring 284) and a top surface 410 that engages with a bottom surface 510 of the mounting brace 106, with bottom surface 510 of mounting brace 106 holding down valve housing 204 against fluid circuit adaptor 122, and maintaining the position of valve housing 204.

Mounting brace 106 functions to house and protect mutually engaging components of valve assembly 202 and electrical actuator 102 from dirt or debris and also, functions as an adaptor to secure and maintain valve housing 204 of valve assembly 202 within the fluid circuit adaptor 122 and in relation to electrical actuator 102 without requiring valve housing 204 to have additional means to be connected to fluid circuit adaptor 122. As further illustrated, mounting brace 106 includes an interior chamber 522 defined by a base 532 (i.e., an interior bottom surface 508 of base 532) surrounded by a wall 530 of sufficient height 524 to accommodate and protect mutually engaging components of valve assembly 202 and electrical actuator 102. A top end of wall 530 of mounting brace 106 diverges parallel to base 532 to form a flange 526.

Base 532 includes opening 504 with alignment and engagement edge 502. As indicated above, The combination of edges 502 of mounting brace 106 in relation to edge 420 of valve housing 204 may be thought of as an interlocking peripheries that interlock at a specific orientation and position to form one of a normally open or normal closed valve and further, the interlock prevents the rotation of valve housing 204 during operation due to the generated torque from electrical actuator 102 that is experienced by value assembly 202 to be opened and closed. Again, the interlocking peripheries 502/420 may be replaced by other mechanism to provide indexing functionality and prevent rotation, non-limiting examples of which may include the use of fasteners (which is less preferred as it would be more labor intensive in terms of installation).

Flange 526 is for coupling mounting brace 106 with electrical actuator 102, and includes an alignment edge 506 for indexing a coupling relationship with electrical actuator 102. More specifically and as best illustrated in FIGS. 5A and 5B, alignment edge 506 defines an indexing relationship between mounting brace 106 and a corresponding edge 538 of alignment section 540 of a bottom exterior surface 536 of second piece 112 of electrical actuator 102 for ease of installation. A surface 516 of flange 526 contacts bottom exterior surface 536 of second piece 112 of electrical actuator 102, while the opposite side 518 is exposed.

Flange 526 includes a first set of apertures 512 for coupling mounting brace 106 with electrical actuator 102 and more specifically, with bottom exterior surface 536 of second piece 112 of electrical actuator 102 contacting the flange 526. It should be noted that the mounting brace 106 is actually secured or fixed to a third shelf 228 (detailed below) via a set of screws 278 (FIG. 2B) that pass through the lower piece housing 112. Accordingly, the mounting brace 106 is secured and fixed in position to third shelf 228, which prevent the mounting brace 106 and hence, the valve assembly 202 from rotating during valve operations. It should further be noted that first set of apertures 512 of mounting brace 106 are not equally distanced, which provide a forced alignment (further defining an indexing relationship) between mounting brace 106 and electrical actuator 102. The indexed positions of apertures 512 are optional but preferred for easier, error free installation.

Base 532 includes a second set of apertures 514 for coupling mounting brace 106 with holes 312 of fluid circuit adaptor 122 using fasteners 276 (FIG. 2B). It should be noted that second set of apertures 514 of mounting brace 106 are not equally distanced, which provide a forced alignment (further defining an indexing relationship) between mounting brace 106 and fluid circuit adaptor 122. The indexed positions of holes 514 are optional but preferred for easier, error free installation.

Second set of apertures 514 of base 532 of mounting brace 106 are positioned near wall 530 and away from opening 504, allowing the remaining portion of base 532 (both interior facing surface 508 and exterior facing surface 510) near the edge of opening 504 to rest against a top 410 of flange 404 of valve housing 204 to hold down, retain, and maintain the position of valve housing 204. More specifically, exterior facing surface 510 of mounting brace 106 rests on top 410 of flange 404 of valve housing 204. It should be noted that although many methods of manufacturing mounting brace 106 exist, one non-limiting exemplary method may include using the well known process of deep draw stamping, which uses a piece of flat sheet of material (e.g., some metal or alloys thereof) and forms it into the illustrated “three dimensional” mounting brace 106.

Referring back to FIGS. 2A to 2C, as illustrated flow control system 100 is fully modularized in that either of electrical actuator 102 or valve system 104 may be independently replaced without an affect on the other. The level of modularization is further granulated to apply to individual systems such as the valve system 104 where either the valve assembly 202 (including its individual components) or the fluid circuit adaptor 122 may be replaced without an affect on the other. The same lower level modularization applies the electrical actuator 102, which is comprised of an electrical device 220 (that includes an isolator switch 234) and a drive train 222 detachably associated with the electrical device 220 for transmission of power for driving the detachably coupled valve system 104.

Electrical device 220 and drive train 222 are secured onto a multilevel rack (or chassis). The multilevel rack is comprised of a first shelf 224 that is detachably coupled with a second shelf 226 by a first set of supports 230. The second shelf 226 is preferably, detachably coupled with a third shelf 228 by a second set of supports 232, but may have a fixed association instead. As illustrated in FIGS. 2A to 2C and FIG. 6A, first shelf 224 supports electrical device 220, including isolator switch 234. That is, electrical device 220 and isolator switch 234 have a common chassis (which is first shelf 224), which can be replaced without replacing drive train 222. Accordingly, the entire flow control system 100 is modularized.

As indicated above and shown in FIGS. 2A to 2C, drive train 222 is secured between second and third shelves 226 and 228. Drive train 222 is used to increase torque output of electrical device 220. Drive train 222 is well known and is comprised of an input shaft 236 with a first end that has an input coupler 238 and a second end that includes an input pinion 240. Drive train 222 includes a gear train with multiple gear reduction stages that have gears that are coupled with pinions to increase torque output. The number of gear reduction stages, including gear sizes and so forth may vary, depending on the amount of torque desired. Drive train 222 includes a final stage output shaft 242 that includes a final stage gear 244 that is coupled with a preceding gear/pinion, with a first distal end 246 associated with manual/override lever or knob and visual indicator 108 and an upper section associated with a switch actuator 248 and a second distal end (via a bearing 266), which is the interlocking interface 218. It should be noted that the interlocking interface 218 may also include O-ring 286 (which are well known and mostly used on explosion proof valves).

As further detailed below, drive train 222 receives motive power at input shaft 236, which is transmitted via gear train as an output torque to the output shaft 242. The rotation of output shaft 242 actuates switch actuator 248 from a first position (e.g., at stop 250) to a second position against a force of a biasing mechanism 252 (e.g., a return torsion spring) while rotating valve stem 210 by interlocking interface 218. It should be noted that input shaft 236 and output shaft 242 are movably secured via bearings 266 within holes of the racks 226 and 228, which facilitate reduction in frictional force between the shafts as they rotate within the holes in the racks. The stop 250 may comprise of cushiony or soft material, which may protect the switch actuator 248. As illustrated in FIGS. 2A to 2C, first distal end 212 of stem 210 is coupled with interlocking interface 218 via the actuator coupler 214, which is also rotated when the output shaft 242 rotates.

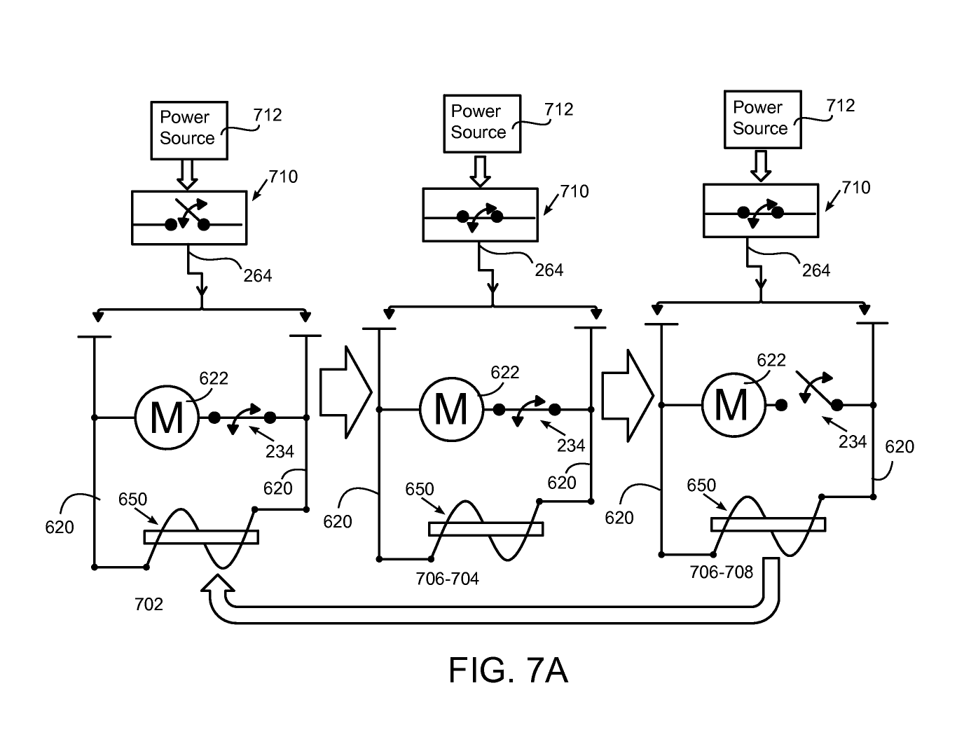

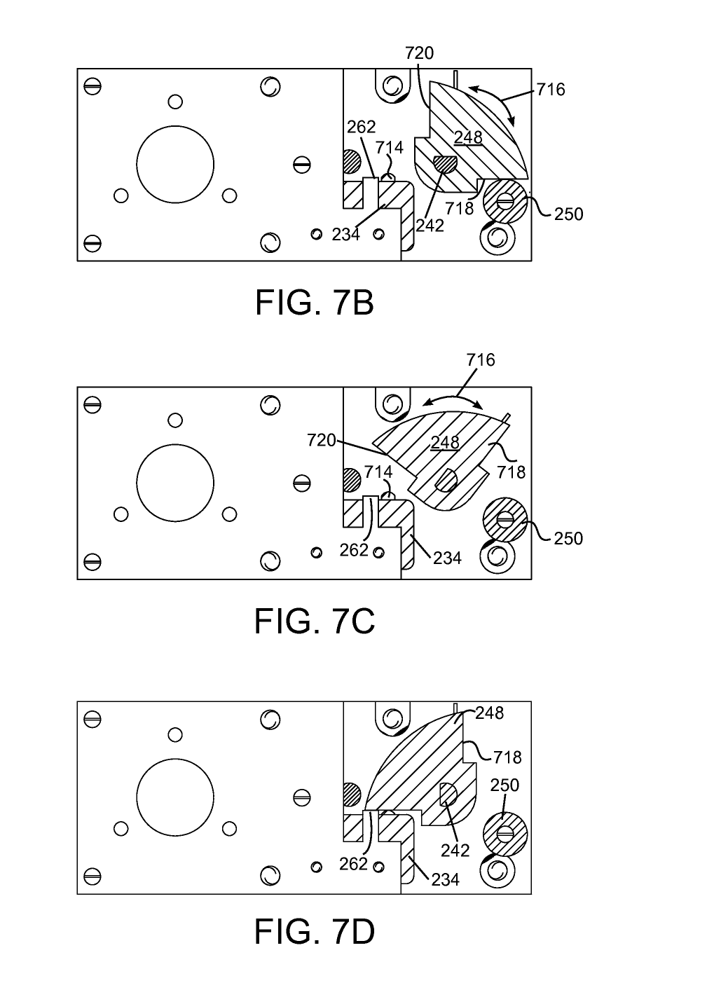

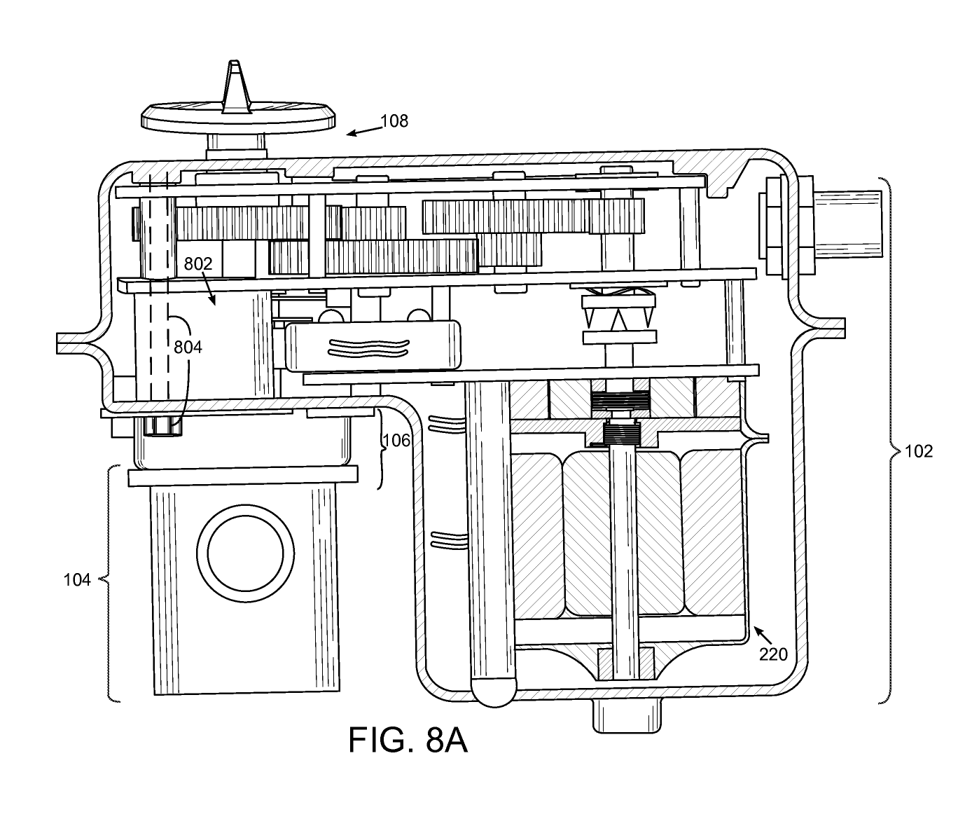

As further illustrated in FIGS. 2A to 2C, and FIGS. 7B to 7D switch actuator 248 has a cam design (somewhat shaped similar to a quarter of a disc) mounted near first distal end 246 of output shaft 242, and includes a bar 260 extended from a bottom thereof. The cam design of switch actuator 248 has sufficient size to enable it to timely actuate isolator switch 234 (detailed below) for one of normally closed or normally open operations. In other words, switch actuator 248 functions to limit motor rotation by actuating isolator switch 234. Associated with switch actuator 248 is biasing mechanism 252 in a form of a return torsion spring with a first end 256 that abuts against a stop-stand 254 of stop 250, and a second end 258 that abuts against bar 260 of switch actuator 248. In this non-limiting, exemplary instance, biasing mechanism 252 under torsion force biases switch actuator 248 to a normally closed position as shown in FIG. 7B.

As indicated above and best illustrated in FIGS. 7B to 7D, the rotation of output shaft 242 actuates switch actuator 248 along reciprocating path 716 from a first position from stop 250 (or normally “closed” position shown in FIG. 7B) to a second position (“open” shown in FIG. 7D) against the force of biasing mechanism 252. As illustrated in FIG. 7B, at first position, switch actuator 248 is away from the normally closed isolator switch 234, with a first side 718 of switch actuator 248 abutting against stop 250. Isolator switch 234 may comprise of an electric plunger switch with an extended plunger 714 that is actuated when a second side 720 of switch actuator 248 contacts to press plunger 714 to open the normally closed isolator switch 234 (FIG. 7D). In other words, isolator switch 234 functions to stop motor 622 at fully open position (for a normally closed valve). As detailed below, opening of isolator switch 234 shuts-OFF power to a motor 622 without disengagement of a rotor shaft 608 from drive train 222.

As indicated above, electrical actuator 102 includes electrical device 220 and isolator switch 234, with electrical device 220 comprised of a first electromagnetic device (such as a motor) and a second electromagnetic device (such as a solenoid) that receive power from a power source via power wires 620. FIGS. 6A and 6B are non-limiting, exemplary detailed illustrations of an electrical device, including electromechanical operations thereof through various modes and phases of operation of flow control system in accordance with one or more embodiments of the present invention. In particular, FIG. 6A is a non-limiting, exemplary detailed illustrations of electrical device 220, including electromechanical operations thereof in a first mode of operation 702 (detailed further below in relation to FIG. 7A), whereas FIG. 6B is a non-limiting, exemplary detailed illustrations of electrical device 220, including electromechanical operations thereof in first and second phases 704 and 708 of a second mode of operation 706 (detailed below in relation to FIG. 7A).

As illustrated in FIGS. 6A and 6B, electrical device 220 includes motor 622 that has a stator assembly 602 and a rotor assembly 686 that have a common central axis 606. The stator assembly 602 is position fixed relative to a housing (motor casing) 624. The rotor assembly 686 is comprised of a rotor 604 and a rotor-shaft 608, with the rotor assembly 686 moving in relation to the stator assembly 602. That is, the rotor assembly 686 has a translational motion 610, moving the entire rotor assembly 686 a distance 614 longitudinally substantially parallel common central axis 606 as well as rotational motion 612 to rotate the entire rotor assembly 686 in relation to stator assembly 602, pivoting it about common central axis 606.

Rotor assembly 686 and in particular rotor-shaft 608 are secured within housing 624 of electrical device 220 by first and second bearings 616 and 618. Housing 624 is comprised of an upper piece 626 that accommodates motor 622 and a lower piece 628 that accommodates a first biasing mechanism 632 and a second biasing mechanism 630. The first biasing mechanism 632 is for biasing (in direction of arrow 634) the rotor assembly 686 to a first axial position 640 in first mode of operation 702 (detailed below) of electric device 220 in relation to stator assembly 602, which places rotor assembly 686 away from a magnetic center of motor 622 (FIG. 6A). In other words, motor 622 has an eccentric magnetic center during first mode of operation 702. As illustrated in FIG. 6A, top 688 of rotor assembly 686 is above top 690 of stator assembly 602 by distance 614. This means that the axial position of rotor assembly 686 during first mode of operation 702 is the mechanical center of motor 622, which is made intentionally different from the magnetic center of the motor 622 due to biasing scheme 632 in accordance with an embodiment of the present invention. The second biasing mechanism 630 is for holding and maintaining (in direction of arrow 654, shown in FIG. 6B) the rotor assembly 686 in a second axial position 648 in a second mode of operation 706 (detailed below) of electric device 220 in relation to stator assembly 602, which maintains rotor assembly 686 at the magnetic center of motor 622 (FIG. 6B). The magnetic center is caused due to the magnetic forces between rotor assembly 686 and stator assembly 602. These magnetic forces tend to ensure that a gap between stator assembly 602 and rotor assembly 686 is as small as possible. Accordingly, rotor assembly 686 of motor 622 moves axially (along 610) to the magnetic center (which is second axial position 648) shown in FIG. 6B when motor 622 is energized and hence, moves rotor shaft 608 to engagement position while being rotated. Further, second biasing mechanism 630 maintains and holds rotor assembly 686 at second axial position 648.

First biasing mechanism 632 is comprised of a resilient member 636 (e.g., a spring) that biases a snap ring 638 in direction 634 to push a brake mechanism 656 and the associated, rotor assembly 686 along path 610 (translational motion) a distance 614 to position and maintain rotor assembly 686 to first axial position 640 as shown in FIG. 6A in the first mode of operation 702 of the electrical device 220. The snap ring 638 fits in a groove 692 (FIG. 6D) of the rotor-shaft 608. In other words, the first biasing mechanism 632 functions to bias rotor assembly 686 away from engagement with drive train 222, and functions to bias brake mechanism 656 away from second biasing mechanism 630 and more particular, a solenoid 650 (detailed below). As illustrated, in the first mode of operation 702 (which is further detailed below) at first axial position 640, rotor assembly 686 is at rest and the rotor-shaft 608 is fully disengaged from drive train 222 due to the rotor assembly 686 pushed away from magnetic center of motor 622 and position at first axial position 640 by first biasing mechanism 632. That is, engagement end 642 of the rotor-shaft 608 is withdrawn from engagement with input coupler 238 of drive train 222.

As further illustrated in FIGS. 6A and 6B, electric device 220 further includes a second biasing mechanism 630 for holding rotor assembly 686 in second axial position 648 (in direction 654 shown in FIG. 6B) in a second mode of operation 706 (detailed below) of electric device 220 in relation to stator assembly 602. Second biasing mechanism 630 is comprised of an electric solenoid 650 that may optionally (and less preferably) include a permanent magnet 652.

Electric solenoid 650 has a center hole that allows passage of rotor-shaft 608 therethrough. When energized in second mode of operation 706, solenoid 650 magnetically couples with brake mechanism 656 to hold and maintain brake mechanism 656 at a fixed position and hence, the associated rotor-shaft 608 at second axially fixed position 648 (as shown in FIG. 6B). Further, when electric device 220 is energized, engagement end 642 of rotor-shaft 608 is fully engaged with input coupler 238 of drive train 222 at second mode of operation 706, and rotating.

Referring to FIGS. 6D and 6E, brake mechanism 656 is comprised of a ferrous metal disc 658 associated with rotor-shaft 608 by a unidirectional motion mechanism 660 placed around rotor-shaft 608 with a first end 662 that is free and a second end 664 that is associated with a cavity 666 of the disc 658. Non-limiting examples of unidirectional motion mechanism 660 may comprise of one-way bearings, one-way helical coil springs, etc. Unidirectional motion mechanism 660 is to enable a one-way rotation of rotor-shaft 608 in relation to the disc 658 in first direction (e.g., one of clockwise or counterclockwise), but prevents rotor shaft 608 from rotating in relation to disc 658 in a second direction (e.g., the other one of counterclockwise or clockwise), opposite the first direction. Stated otherwise, in one direction, unidirectional motion mechanism 660 will tightly grip the rotor shaft 608 and force disc 658 to rotate in the same direction and speed as rotor shaft 608. In the opposite direction, the disc 658 is free to rotate independent of rotor shaft 608. When the disc 658 is in full contact with solenoid 650, the disc 658 will be prevented from rotating in either direction. This means that rotor shaft 608 will also be prevented from rotating, with the unidirectional motion mechanism 660 tightly griping the rotor shaft 608, opposing biasing mechanism 252.

As further illustrated in FIGS. 6D and 6E, disc 658 includes a housing 668 generally positioned at a radial center of disc 658 that has through-hole for insertion and maintaining rotor-shaft 608, and also, accommodating unidirectional motion mechanism 660. The through-hole has a wider opening at top 670 and a narrower opening at bottom 672, defined by flanges 674a and 674b. Flanges 674a and 674b support and maintain the position of unidirectional motion mechanism 660 within housing 668. Top surface 676 of housing 668 (which is protruded from top surface 678 of disc 658 by height 680) contacts a bottom end 682 of rotor 604 whereas a bottom surface 684 of disc 658 (underneath housing 668) contacts the top surface of snap spring 638 of first biasing mechanism 632. The snap ring 638 fits inside the groove 692 and with the help of the resilient member 636, pushes against the rotor shaft 608 and bottom surface 684 of disc 658.

Referring to FIGS. 6A, 6B, 6D, and 6E, in first mode of operation 702 when electric device 220 is not energized, resilient member 636 pushes against snap ring 638 to bias rotor assembly 686 to first axial position 640. That is, resilient member 636 pushes the biasing mechanism 632 locked within groove 692 in direction 634, which moves the rotor shaft 608 and rotor 604, including disc 658 to axial position 640 (FIG. 6A). This first “clutch” action in first mode of operation 702 disconnects engagement end 642 of rotor shaft 608 from input coupler 238. In general, clutch action may be defined as a function of connecting and disconnecting of electric device 220 from drive train 222. In a second mode of operation 706 when electric device 220 is energized, rotor assembly 686 is moved to magnetic center (while rotating) due to generated magnetic field coupling between rotor assembly 686 and stator assembly 602, with bottom 682 of rotor 604 pushing against top surface 676 of housing 668 of disc 658, which moves disc 658 in direction 654 to push snap ring 638 against the bias of resilient member 636 (as shown in FIG. 6B). In other words, bottom surface 684 contacts the top surface of solenoid 650. During second mode of operation 706 second biasing mechanism 630 retains and holds (via magnetic coupling detailed below) the position of disc 658 and hence, rotor shaft 608 at second axial position 648 as shown in FIG. 6B. This second “clutch” action in second mode of operation 706 connects engagement end 642 of rotor shaft 608 with input coupler 238. It should be noted that as best illustrated in FIG. 2A to 2C, the input coupler 238 includes an optional cushioning mechanism in a form of a spring washer 282 that cushions the impact of the contact of the engagement end 642 with input coupler 238 for the second clutch action.

It should be noted that as illustrated in FIG. 6C, engagement end 642 and input coupler 238 may comprise of a variety of different interface configurations 644 or 646. Interface configurations 646 or 644 are located between the input-shaft 236 of the drive train 222 and rotor shaft 608 of rotor assembly 686. Interface configurations 644 or 646 are designed to couple the axially moveable rotor shaft 608 with the axially stationary input shaft 236 of drive train 222 when rotor shaft 608 is moved towards drive train 222 in an “extended position.” Interface configurations 644 and 646 disengage when rotor shaft 608 is axially moved from input shaft 236 of drive train 222 in a “contracted position.” It should be noted that for interface configuration 646, the mating points of the blade 642 of rotor shaft 608 and spikes 238 of input shaft 236 is made angular promoting an axial “push to disconnect” as the “jaw” coupling rotate during second phase 708 of second mode of operation 706. This “push to disconnect” feature helps disconnect the upper and lower “jaws” 642 and 238 initially when the solenoid's hold on the motor rotor assembly 686 is released. It should be noted that the benefit of using interface configuration 644 is that the opposing contact surfaces form a full contact when engaged and therefore, ideal for high gear ratio drive train.

FIG. 7A is non-limiting, exemplary illustration of electrical schematic for flow control system, showing various modes and phases of operation in accordance with one or more embodiments of the present invention. FIGS. 7B to 7D are non-limiting, exemplary illustrations of progressive movement of a switch actuator in accordance with one or more embodiments of the present invention. In view of FIGS. 2A to 2C, 6A and 6B, and 7A to 7D, and as mentioned above, electric device 220 has first mode of operation 702 with no power supplied to electric device 220, first phase 704 of second mode of operation 706 with power supplied to electric device 220, and second phase 708 of second mode of operation 706 with power supplied to second biasing mechanism 630 of electric device 220, only.

As indicated in FIG. 7A, circuit schematics of electric wiring include a power source 712 coupled with a first electromagnetic device (e.g., motor 622) and a second electromagnetic device (e.g., solenoid 650) via a main power switch 710. Further included is an isolator (e.g., isolator switch 234) that isolates one of a first or second electromagnetic device during one of a first or a second mode of operations of one of the first or second electromagnetic device. As indicated above and in relation to FIGS. 7B to 7D, switch actuator 248 actuates isolator switch 234 from a normally closed position (first mode of operation 702) to an open position (second phase 708 of second mode of operation 706).

Isolator switch 234 is coupled in series with motor 622, and the combined series connected motor 622 and isolator switch 234 are coupled in parallel with solenoid 650. In other words, isolator switch 634 is series connected with motor 622, with the combine series connected motor 622 and isolator switch 634 connected between a power line and neutral. Solenoid 650 is coupled in parallel with the combined series connected motor 622 and isolator switch 634, where isolator switch 234 in open condition (second phase 708 of second mode of operation 706) isolates motor 622 from power source 712 while power is continuously supplied to solenoid 650 via main power switch 710. In other words, during the first mode of operation 702 and first phase 704 of second mode of operation 706, isolator switch 234 is closed, placing motor 622 and solenoid 650 in parallel, and during second phase 708 of second mode of operation 706, isolator switch 234 is open, isolating motor 622 from power source 712 while power is continuously supplied via closed main power switch 710 to solenoid 650, only. Stated otherwise, during first mode of operation 702 and first phase 704 of second mode of operation 706, switch actuator 248 is at rest (FIG. 7B) or at a transition (FIG. 7C), moving along path 716 towards isolator switch 234 to open the normally closed switch 234.

As indicated above, rotor assembly 686 of motor 622 is biased to first axial position 640 in first mode of operation 702 by first biasing mechanism 632 (FIG. 6A), with the motor 622 at its mechanical center (away from its magnetic center). As illustrated in FIGS. 7A to 7D, in first mode of operation 702, main power source 712 to electrical device 220 is OFF, represented by the open switch condition of main power switch 710. During first mode of operation 702 (also shown in FIG. 6A), electrical device 220 generates no motive power, motor 622 is at its mechanical center (which is intentionally made different from its magnetic center), and rotor shaft 608 is fully disengaged from drive train 222 due to rotor assembly 686 being at mechanical center of motor 622 and away from the magnetic center of motor 622. This also means that switch actuator 248 is at first position (FIG. 7B).

In first phase 704 of second mode of operation 706, power 712 is supplied to electric device 220 (both motor 622 and solenoid 650), rotating and axially moving rotor assembly 686 to second axial position 648 (magnetic center of motor 622) against the opposing force of first biasing mechanism 632, thus compressing resilient member 636 of biasing mechanism 632 as illustrated in FIG. 6B. More specifically, in first phase 704 of second mode of operation 706, when power 712 is applied to motor 622 and solenoid 650, the rotor assembly 686 and rotor-shaft 608 in particular are set in motion from the mechanical center of motor 622 to its magnetic center. Supplied power 712 received by stator assembly 602 of motor 622 (including solenoid 650) axially moves rotor assembly 686 to magnetic center of motor 622 (FIG. 6B) due to generated magnetic force between stator assembly 602 and rotor assembly 686, with the magnetic force overcoming the opposing force of resilient member 636 to thereby drive rotor assembly 686 to second axial position 648 while rotor assembly 686 is rotated. At second axial position 648, the rotor shaft 608 becomes fully engaged with drive train 222. That is, at second axial position 648, which is the magnetic center (FIG. 6B) of motor 622, engagement end 642 of rotor-shaft 608 engages with input coupler 238 of input shaft 236 of drive train 222, which is rotated by rotation of rotor-shaft 608.

While rotor assembly 686 is in motion (axial and rotational), solenoid 650 now energized provides a magnetic force that is applied to the ferrous disc 656 that is affixed to rotor shaft 608 via unidirectional motion mechanism 660. As rotor assembly 686 nears, or reaches, magnetic center, disc 656, which might now be rotating with rotor shaft 608 will engage solenoid 650, and will immediately cease to rotate, partly due to magnetic dampening forces but mainly due to friction between contacting surfaces of solenoid 650 and disc 656. However, because disc 656 is coupled with rotor shaft 608 via unidirectional motion mechanism 660, rotor shaft 608 will continue to rotate, in fact accelerate in terms of Revolutions Per Minute (RPM) while power continues to be supplied to motor 622. Because rotor shaft 608 is now engaged with input shaft 236 of drive train 222 via couplings 242/238, the rotation of rotor shaft 608 is transferred from motor 622 to input shaft 236, and to output shaft 242 causing output shaft 242 to rotate in a specific direction. This will, in turn, cause valve system 104, which is connected to output shaft 242 via valve stem 210, to move to a fully open position.

It should be noted that undersurface 684 of disc 658 magnetically couples with and contacts solenoid 650, and is made of “roughened” surface to prevent slippage once disc 658 is in contact with the solenoid 650. The energized solenoid 650 magnetically maintains disc 658 in contact with solenoid 650 against the force of first biasing mechanism 632, with friction further facilitating the hold between disc 658 and solenoid 650 so that rotor-shaft 608 is maintained at the fixed axial position while rotating, fully engaged with input shaft 236 of drive train 222. It should further be noted that for larger applications, the disc 658/solenoid 650 combination may be replaced by an interlocking mechanisms.

The biasing mechanism (e.g., return torsion spring) 252, which is pivoted onto output shaft 242 would be placed under greater and greater torsion force during first phase 704 of second mode of operation 706. In other words, the interface couplings (646 or 644) radial motion will exert an axial pressure onto rotor shaft 608 prompting the interface coupling 644/646 to attempt to disconnect. This axial pressure is mitigated mostly by solenoid 650, and to a lesser extent by the motor's magnetic center, all acting onto the interface coupling in the opposite direction to the applied torsion force of biasing mechanism 252, helping the interface coupling to remain connected.

As indicated above, drive train 222 includes input shaft 236 that receives motive power from electric device 220 during first phase 704 of second mode of operation 706. Output shaft 242 of drive train 222 simultaneously transmits the received motive power to switch actuator 248 (FIGS. 7A and 7B) and valve system 104 during first phase 704 of second mode of operation 706 to thereby operate valve system 104 and isolate motor 622, commencing second phase 708 of second mode of operation 706. That is, as rotor-shaft 608 rotates to rotate input shaft 236 of drive train 222, output shaft 242 is rotated via transfer of torque through the gear train of drive train 222 from input shaft 236. The rotating torque-force experienced by output shaft 242 sets into motion switch actuator 248 along path 716 from rest position (FIG. 7B) against the torsion force of biasing mechanism 252. As switch actuator 248 continues to move along path 716 (FIG. 7C), biasing mechanism 252 continues to store mechanical energy as it is twisted, which in turn, exerts a counter force (or opposite torque) in opposite direction, proportional to the angle biasing mechanism 252 is twisted. This opposite torque of biasing mechanism 252 is less than the force experienced by output shaft 242 and hence, switch actuator 248 continues to move along path 716 as indicated in FIGS. 7B to 7C. The rotation of output shaft 242 continues until valve system 104 is fully open, which is the point where second side 720 of switch actuator 248 contacts plunger 714 of the normally closed isolator switch 234 to open isolator switch 234.

As best illustrated in FIGS. 2C and 7B to 7D, first shelf 224 includes a flange 262 that extends and bends over next to the plunger 714 of the isolator switch 234. In general, the thickness of the flange 262 is greater than the height of the plunger 714 when at retracted position. This enables the second side 720 of the switch actuator 248 to come to rest on the flange 262, which protects the plunger 714 against the strong mechanical impact of second side 720. Stated otherwise, flange 262 has sufficient thickness that allows plunger 714 to be actuated but not to its breaking point. It should be noted that other methods of “stop” mechanisms to protect plunger 714 of isolator switch 234 against the force of switch actuator 248 are possible, including use of a simple piece of rubber next to plunger 714 or modification of the surface of the second side 720. Pressing of plunger 714 opens isolator switch 234 and commences second phase 708 of second mode of the operation 706.

In second phase 708 of second mode of operation 708, power is continued to be supplied only to second biasing mechanism 630 for retaining and maintaining or holding rotor assembly 686 at second axial position 648 against exerted force of biasing mechanism 632 and also, against the exterted force of biasing mechanism 252 (which is experienced by output shaft 242 via the drive train 222). As indicated above, second biasing mechanism 630 is comprised of solenoid 650 that magnetically couples with disc 658 to hold and maintain disc 658 at a fixed position and hence, the associated rotor-shaft 608 at second axial position 648.

During second phase 708 of second mode of operation 706, disc 658 and hence, rotor-shaft 608 are maintained fixed at second axial position 648, with rotor-shaft 608 fully extended and engaged with input shaft 236 of drive train 222, with the valve system fully operational and having an ON state while motor 622 is OFF as a result of position of switch actuator 248 contacting isolator switch 234 to open it and shut-off power to motor 622. The OFF state of motor 622 stops rotation of rotor-shaft 608, with rotor-shaft 608 still maintained at second axial position 248 fully engaged with input shaft 236 of drive train 222. Disc 658 is prevented from rotating by friction between magnetically coupled surfaces of the disc 658 and the solenoid 650 while the unidirectional mechanism locks the disc 658 and rotor-shaft 608 together rotationally thus enabling the disc 658 to prevent the rotor-shaft 608 from rotating. In other words, ultimately, rotor-shaft 608 is prevented from rotating in reverse (due to the exerted force from biasing mechanism 252) by unidirectional motion mechanism 660 which prevents the disc 658 and hence, the associated rotor-shaft 608 from rotating in reverse while rotor-shaft 608 is fully engaged with the input of drive train 222. This maintains drive train 222 at position and hence, valve system 104 in the ON state. Unidirectional motion mechanisms 660 in combination with solenoid 650 and the friction of the disc/solenoid combination counter the mechanical forces of biasing mechanism 252. Accordingly, the disc/solenoid combination facilitate a holding pattern of rotor-shaft 608 at second axial position 248 (while motor 622 is OFF) and unidirectional motion mechanism 660 in combination with the disc/solenoid facilitates a holding pattern of rotor-shaft 608 at a radial (or rotational) position where it can be rotated in only one direction, opposite that of switch actuator 248 motion, against biasing mechanism 252.

Disc 658 maintains rotor-shaft 608 engaged with input shaft 236 of drive train 222 during second phase 708 of second mode of operation 706 while motor 622 is OFF, all due to the magnetic coupling between disc 658 and the energized solenoid 650 plus the unidirectional motion mechanism 660, countering the force of the biasing mechanism 252. At this stage, the valve is fully open, enabling fluid flow for as long as solenoid 650 is energized. In other words, electromechanical biasing scheme (solenoid, disc, unidirectional mechanism) is provided that generates a holding strength that is maintained against stored mechanical energy of biasing mechanism 252 of switch actuator 248. Accordingly, this allows valve system 104 to maintain the ON state for as long as desired (with motor 622 OFF).

If power is shut-off to solenoid 650, rotor-shaft 608 disengages with input shaft 236 of drive train 222 due to first biasing mechanism 632 pushing rotor-shaft 608 up and away from drive train 222. In other words, once power is fully shut-off, solenoid 650 is de-energized and rotor assembly 686 with disc 658 is pushed up and away from solenoid 650 by first biasing mechanism 632, disengaging rotor shaft 608 from input shaft 236 of drive train 222. This means that switch actuator 248 with the stored energy within biasing mechanism 252 therein will close off the valve. That is, biasing mechanism 252 is now free to untwist and to rotate quickly and speedily drive the switch actuator 248 (and the output shaft 242) to first position to thereby rotate output shaft 242 and shut-off valve system 104. It should be noted that rotation of switch actuator 248 under torsion force of biasing mechanism 252 rotates output shaft 242, which is associated with valve system 104. If power 712 is fully disconnected before valve has reached fully open position, motor 622 will stop turning and solenoid 650 will de-energize, releasing disc 658. The release of disc 658 will allow compression spring 636 to “push” rotor shaft 608 away from drive train 222 prompting interface coupling 644/646 to disconnect, disengaging motor 622 and drive train 222.

As shown in FIG. 7A, cycling back to first mode of operation 702, rotor-shaft 608 fully disconnects and disengages from input shaft 236 of drive-train 222 to thereby allow biasing mechanism 252 speedily return valve system 104 to an OFF state. Once power 712 is fully shut-off due to main power switch 710 opening, the mode of operation is cycled back to first mode of operation 702 from second phase 708 of second mode of operation 706. As indicated above, in first mode of operation 702, rotor-shaft 608 disengages from input shaft 236 as no power is supplied to motor 622 to move it axially and rotate it and further, no power is supplied to solenoid 650 to maintain the position of rotor shaft 608. Accordingly, switch actuator 248 is driven freely and speedily returns to first position (FIG. 7B) from second or engaging position (FIG. 7D) due to the stored mechanical energy in biasing mechanism 252. That is, since there is no electromotive force to counter the stored mechanical energy in biasing mechanism 252, that stored energy in biasing mechanism 252 sets into motion switch actuator 248 along path 716 from engagement position with isolator switch 234 (FIG. 7D) to the first position shown in FIG. 7B, which speedly rotates output shaft 242 to quickly close valve system 104.

As indicated above and best illustrated in FIGS. 1 to 2C, an embodiment of the flow control system of the present invention also provides manual/override visual indicator knob 108 for manually opening and closing valve system 104, which is accessible by users, installers, or maintenance personal. Manual lever or actuator 108 is associated with output shaft 242 of drive train 222, enabling manual operation of valve system 104. The orientation of manual actuator 108 provides a visual indicator of whether the valve system is in an ON (or open) or OFF (or closed) state. Manual actuator 108 and in fact, the entire flow control system may be configured as one of normally open or normally closed systems.

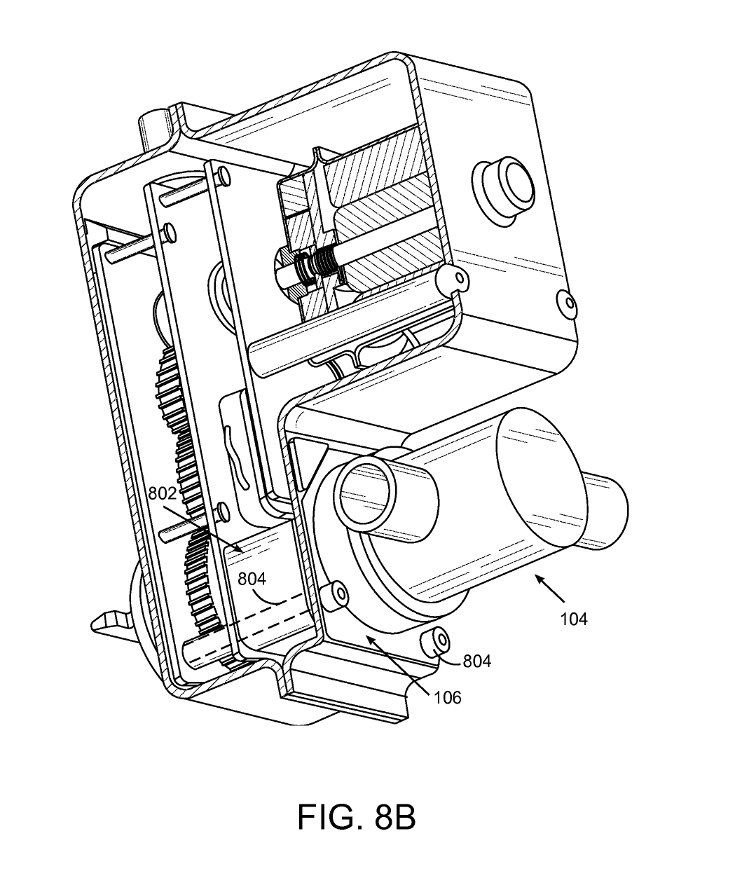

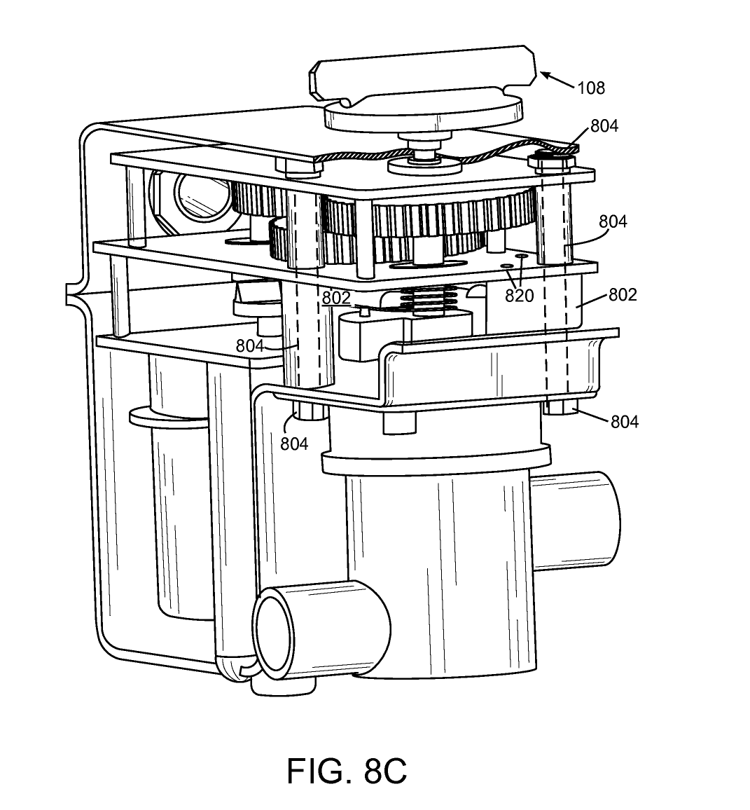

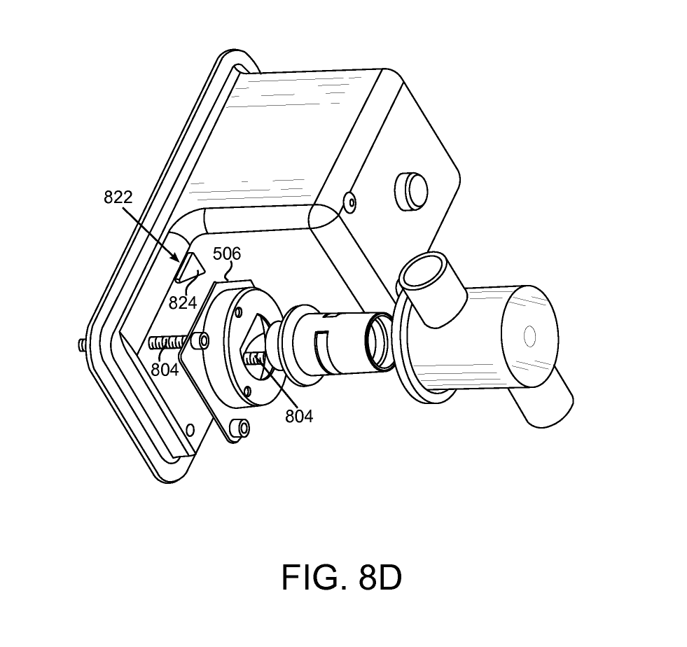

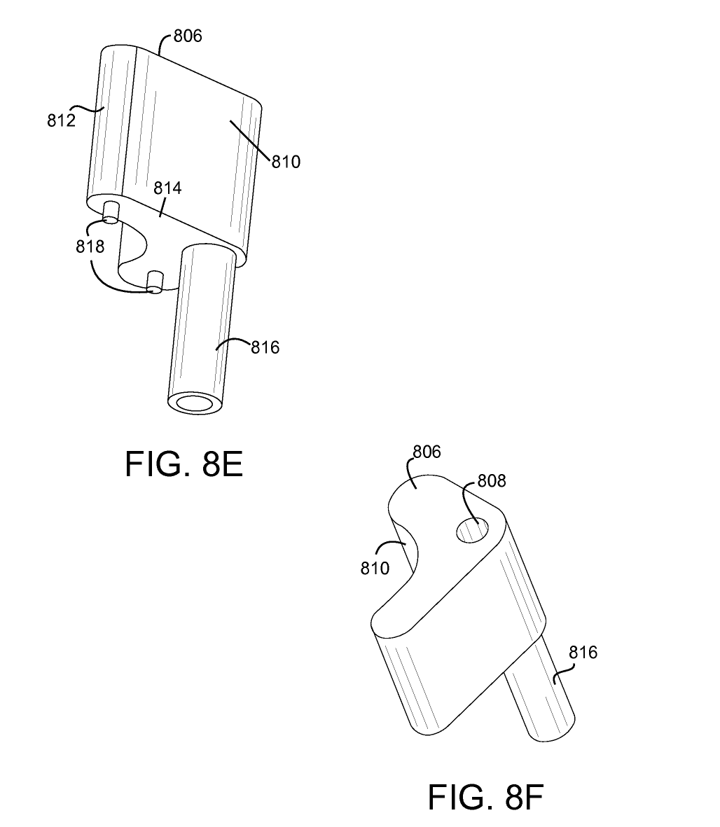

FIGS. 8A to 8F are non-limiting, exemplary illustrations of a flow control system in accordance with one or more embodiments of the present invention where the location of the manual lever and valve system is switched, forming a more compactly configured flow control system. The flow control system illustrated in FIGS. 8A to 8F includes similar corresponding or equivalent components, interconnections, functional, and or cooperative relationships as the flow control system that is shown in FIGS. 1 to 7D, and described above. Therefore, for the sake of brevity, clarity, convenience, and to avoid duplication, the general description of FIGS. 8A to 8F will not repeat every corresponding or equivalent component, interconnections, functional, and or cooperative relationships that has already been described above in relation to flow control system that is shown in FIGS. 1 to 7D. As illustrated in FIGS. 8A to 8F, manual lever 108 is now positioned at the opposite side of the electrical actuator, with the valve system 104 adjacent and at the same side and elevation as the electrical device 220 and the lever at the opposite side and elevation as the electrical device. This arrangement would make the height of valve system 104 commensurate in direction and orientation with that of the electrical device 220. This reduces the overall size (in terms of height in the Y-axis) of the entire flow control system, making it a more compact form, as the height of the electrical device 220 would be comparably the same as that of the valve system 104, which would make it more compact. However, this would make it a more difficult to access the motor to replace it.

As further illustrated, in this embodiment, the mounting brace 106 functions the same as disclosed above, with appropriate indexing (alignment features) for normally open and or normal closed flow control system. In this embodiment, the alignment edge 506 defines an indexing relationship between mounting brace 106 and a corresponding edge 822 of alignment section 824 of a top exterior surface of first piece 110 of electrical actuator 102 for ease of installation.

It should be noted that unlike the previous embodiments where mounting brace 106 is secured to the third shelf 228 by a set of fasteners such as screws, in this embodiment, there is no nearby shelf to which the mounting brace 106 may be secured. As illustrated, the first shelf 224 has a shorter span and therefore, mounting brace 106 cannot be fastened to its closest shelf 224. Accordingly, in this non-limiting, exemplary embodiment, the present invention provides supports 802 that provide structural support to hold mounting brace 106 and securely maintain the position of value assembly 202 during operation by fasteners 804.

As best illustrated in FIGS. 8E and 8F, the supports 802 are comprised of a top 806 that provides a structural support for securing mounting brace 106, with top 806 including a hole 808 for insertion of fastener such as a screw 804. The supports 802 further include a body 810 configured to accommodate free motion of switch actuator 248 and smooth lateral sides 812 to provide the same function as stop 250. Hole 808 has an axial length that extends beyond body 810, protruding from bottom end 814, forming a post 816. Fasteners 804 have sufficient lengths that extend out of posts 816 to secure with third shelf 228. Bottom end 814 further includes protrusions 818 that function to interlock with holes 820 on second shelf 226, to therefore secure the supports 802 in relation to the rack system. In other words, supports 802 are secured and interlocked with the rack system at three points via the post 816 and the two protrusions 818.

Although the invention has been described in considerable detail in language specific to structural features and or method acts, it is to be understood that the invention defined in the appended claims is not necessarily limited to the specific features or acts described. Rather, the specific features and acts are disclosed as exemplary preferred forms of implementing the claimed invention. Stated otherwise, it is to be understood that the phraseology and terminology employed herein, as well as the abstract, are for the purpose of description and should not be regarded as limiting. Therefore, while exemplary illustrative embodiments of the invention have been described, numerous variations and alternative embodiments will occur to those skilled in the art. For example, disc 658 of brake mechanism 656 need not be a circular disc, but may comprised of other shapes. As another example, valve assembly and the external fluid circuit may have interlocking peripheries or, alternatively, the mounting brace may be detachably secured with the electrical actuator and the valve assembly. As a further example, the mounting brace may be detachably secured with the electrical actuator and both the external fluid circuit and the valve assembly. As another example, the flow control system in accordance with the present invention may be implemented as normally open or normally closed system by mere replacement and use of correct brace 106 and lever 108. Such variations and alternate embodiments are contemplated, and can be made without departing from the spirit and scope of the invention.

It should further be noted that throughout the entire disclosure, the labels such as left, right, front, back, top, bottom, forward, reverse, clockwise, counter clockwise, up, down, or other similar terms such as upper, lower, aft, fore, vertical, horizontal, oblique, proximal, distal, parallel, perpendicular, transverse, longitudinal, etc. have been used for convenience purposes only and are not intended to imply any particular fixed direction or orientation. Instead, they are used to reflect relative locations and/or directions/orientations between various portions of an object.

In addition, reference to “first,” “second,” “third,” and etc. members throughout the disclosure (and in particular, claims) is not used to show a serial or numerical limitation but instead is used to distinguish or identify the various members of the group.

In addition, any element in a claim that does not explicitly state “means for” performing a specified function, or “step for” performing a specific function, is not to be interpreted as a “means” or “step” clause as specified in 35 U.S.C. Section 112, Paragraph 6. In particular, the use of “step of,” “act of,” “operation of,” or “operational act of” in the claims herein is not intended to invoke the provisions of 35 U.S.C. 112, Paragraph 6.

What is claimed is:

1. An electric device, comprising:
a first mode of operation with no power supplied to the electric device;
a first phase of a second mode of operation with power supplied to the electric device; and
a second phase of the second mode of operation with power supplied to a biasing mechanism of the electric device, only.

2. The electric device as set forth in claim 1, further comprising:
a motor.

3. The electric device as set forth in claim 2, wherein:
the motor includes a rotor assembly that is biased to a first axial position in the first mode of operation.

4. The electric device as set forth in claim 3, wherein:
the rotor assembly is biased to a second axial position in the second mode of operation.

5. The electric device as set forth in claim 3, wherein:
the motor is switched OFF in the second phase of the second mode of operation.

6. An electric device, comprising:
a motor;
a first biasing mechanism for biasing a rotor assembly of the motor to a first axial position in a first mode of operation of the electric device; and
a second biasing mechanism for holding the rotor assembly of the motor in a second axial position in a second mode of operation of the electric device.

7. The electric device as set forth in claim 6, wherein:
the first biasing mechanism includes:
a resilient member that biases and maintains the rotor assembly in the first axial position during the first mode of operation.

8. The electric device as set forth in claim 6, wherein:
during the first mode of operation, no power is supplied to the electric device; and
during a first phase of the second mode of operation, power is supplied to the electric device; and
during a second phase of the second mode of operation, power is only supplied to the second biasing mechanism.

9. The electric device as set forth in claim 8, wherein:
during the second phase of the second mode of operation the motor is isolated and is switched OFF by a switch while power continues to be supplied to the second biasing mechanism.

10. The electric device as set forth in claim 8, wherein:
during the first phase of the second mode of operation power is supplied to both the motor and the second biasing mechanism; and
during the second phase of the second mode of operation power is switched OFF to motor while power continues to be supplied to the second biasing mechanism.

11. The electric device as set forth in claim 6, wherein:
one of the first and the second modes of operations further define one of an engagement and disengagement of the electrical device with an external device.

12. The electric device as set forth in claim 6, wherein:
the second biasing mechanism is a solenoid.

13. The electric device as set forth in claim 9, wherein:
the switch is opened to isolate and turn OFF motor.

14. The electric device as set forth in claim 9, wherein:
the switch is a normally closed switch.

15. The electric device as set forth in claim 6, wherein:
the rotor assembly is biased away from a magnetic center of the motor.

16. The electric device as set forth in claim 6, wherein:
the second axial position is a magnetic center of the motor.

17. The electric device as set forth in claim 6, wherein:
the motor further includes a stator assembly that has a common central axis with the rotator assembly.

18. The electric device as set forth in claim 6, further comprising:
housing, with a stator assembly position fixed relative to the housing.

19. The electric device as set forth in claim 6, wherein:
rotor assembly 204 includes a rotor and an associated rotor-shaft.

20. A control circuit, comprising:
a power source coupled with a first electromagnetic device and a second electromagnetic device; and
an isolator that isolates one of a first or second electromagnetic device during one of a first or a second mode of operations of one of the first or second electromagnetic device.

21. The control circuit as set forth in claim 20, wherein:
the first electromagnetic circuit is a motor;
the second electromagnetic circuit is a solenoid; and
the isolator is a switch.

22. The control circuit as set forth in claim 21, wherein:
the switch is coupled in series with the motor, and the combined series connected motor and switch are coupled in parallel with the solenoid.

23. The control circuit as set forth in claim 22, wherein:
during the first mode of operation:
the series coupled switch is closed, placing the motor and the solenoid in parallel; and
during the second mode of operation:
the series coupled switch is open, isolating the motor from the power source while power is continuously supplied to the solenoid.

24. A control circuit, comprising:
a switch that is series connected with a motor, with the combine series connected motor and switch connected between a power line and neutral;
a solenoid that is coupled in parallel with the combined series connected motor and switch, with the switch in an open condition isolating the motor from the power source while power is continuously supplied to the solenoid.

25. An electrical actuator, comprising:
an electrical device; and
a drive train detachably associated with the electrical device for transmission of power for driving a detachably coupled external equipment.

26. The electrical actuator as set forth in claim 25, wherein:
the electrical device includes:
a motor that has a stator assembly and a rotor assembly that have a common central axis;
the rotor assembly having a rotor and a rotor-shaft, with the rotor assembly moving in relation to the stator assembly;
a first biasing mechanism for biasing the rotor assembly of the motor to a first axial position in a first mode of operation of the electric device in relation to the stator assembly; and
a second biasing mechanism for biasing the rotor assembly of the motor in a second axial position in a second mode of operation of the electric device in relation to the stator assembly;
in a first phase of the second mode of operation, power is supplied to the electric device, rotating and axially moving the rotor assembly to the second axial position against an opposing force of the first biasing mechanism; and
in a second phase of the second mode of operation, power is only supplied to the second biasing mechanism for holding the rotor assembly at the second axial position, and preventing reversal rotational motion of the rotor-shaft.

27. The electrical actuator as set forth in claim 26, wherein:
during first mode of operation:
the electrical device generates no motive power, and is fully disengaged from the drive train due to the rotor assembly being away from a magnetic center of the motor caused by the first biasing mechanism.

28. The electrical actuator as set forth in claim 26, wherein:
during the first phase of the second mode of operation:
power is supplied to the motor which, in turn, axially moves the rotor assembly to a magnetic center of the motor due to a generated magnetic force between the stator assembly and the rotor assembly, with the magnetic force overcoming an opposing force of the first biasing mechanism, which drives the rotor assembly to the second axial position while the rotor assembly is rotated;
at the second axial position, which is the magnetic center of the motor, the rotor-shaft engages with an input of the drive train, which is rotated thereby.

29. The electrical actuator as set forth in claim 27, wherein:
the drive train includes:
the input that receives motive power from the electric device during the first phase of the second mode of operation; and
an output that simultaneously transmits the received motive power to a switch actuator and an external equipment during the first phase of the second mode of operation to actuate the external equipment, with the switch actuator finally isolating the motor to commence the second phase of the second mode of operation;
during the second phase of the second mode of operation, the motor is OFF and the input of the drive train is maintained at a fixed position with full engagement with the rotor-shaft until power to electrical device is shut-OFF at which point, the rotor-shaft disengages from the input of the drive train, with the switch actuator freely and speedily returning to rest position.

30. The electrical actuator as set forth in claim 26, wherein:
the second biasing mechanism is comprised of:
a brake mechanism that maintains and holds the rotor-shaft at a fixed axial position;
the brake mechanism includes:
a disc associated with the rotor-shaft;
a unidirectional motion mechanism;
the unidirectional motion mechanism enables a one-way rotation of the rotor shaft in first direction, but prevents the rotor shaft from rotating in a second direction, opposite the first direction; and
a solenoid that magnetically couples with the disc to hold and maintain the disc at a fixed position and hence, the associated rotor-shaft at an axially fixed position.

31. The electrical actuator as set forth in claim 30, wherein:
during the first phase of the second mode of operation:
the motor is energized, the rotor-shaft rotates and is also axially moved to the second axial position;
an undersurface of the disc magnetically couples with and contacts the solenoid;
the energized solenoid magnetically maintains the disc in contact with the solenoid against the force of the first biasing mechanism, with friction further facilitating the hold between the disc and the solenoid so that the rotor-shaft is maintained at the fixed axial position while rotating, fully engaged with the input of the drive train;
during the second phase of the second mode of operation:
the disc and the rotor-shaft are maintained fixed at second axial position, with the rotor-shaft fully extended and engaged with the input of the drive train, with the external equipment fully operational and having an ON state while the motor is OFF as a result of position of the switch actuator;
the OFF state of the motor stops rotation of the rotor-shaft, with the rotor-shaft maintained at the second axial position fully engaged with the input of the drive train;
the disc is prevented from rotating by friction between surfaces of the disc and the solenoid while the unidirectional mechanism locks the disc and rotor-shaft together rotationally thus enabling the disc to prevent the rotor-shaft from rotating.

32. The electrical actuator as set forth in claim 31, wherein:
during the first mode of operation, the rotor-shaft fully disconnects and disengages from the input of the drive-train to thereby speedily return the external equipment to an OFF state.

33. The electrical actuator as set forth in claim 32, wherein:
the electrical device and the switch have a common chassis, facilitating easy of replacement of both without affecting the drive-train.

34. The electrical actuator as set forth in claim 33, further comprising:
a manual actuator associated with the output of the drive-train, enabling manual operation of the external equipment, with an orientation of the manual actuator providing a visual indicator of the operating status of the external equipment;
where: the manual actuator is one of normally open or normally closed.

35. The electrical actuator as set forth in claim 34, wherein:
the external equipment and the electrical device are adjacent and are oriented in common in the same direction.

36. The electrical actuator as set forth in claim 29, wherein:
at an engagement position the switch actuator abutts a flange, preventing the switch actuator from damaging the isolator, and at rest position the switch actuator abutts against cushiony stop to thereby protect the switch actuator from damage due to high speed of return of the switch actuator under bias of a return spring.

37. A valve assembly, comprising:
a valve housing that includes a valve mechanism that controls inflow of liquid from an inlet port for a controlled outflow of liquid to an outlet port;
the valve housing defines an axis of rotation for a valve stem that pivots about the axis of rotation for opening and closing the valve mechanism.

38. The valve assembly as set forth in claim 37, wherein:
the valve stem includes:
a first end that extends out of the valve housing and is associated with an actuator by an actuator coupler;
a second end that is associated with the valve mechanism.

39. The valve assembly as set forth in claim 38, wherein:
a top surface of the valve housing is comprised of a raised surface with an alignment engagement edge for alignment and engagement with an edge of a bottom opening of a mounting brace to prevent the valve housing from rotation during operation, and allow for easy installation for one of a normally open or a normally closed operational modes of the valve;
the raised surface further includes an opening through which the first end of the valve stem extends;
the top surface of the valve housing is further comprised of a recessed portion forming a flange with a bottom that rests on an external fluid circuit and a top that receives a bottom surface of the mounting brace, with the bottom surface of the mounting brace holding down the valve housing against the external fluid circuit, and maintaining the position of the valve housing.

40. A mounting brace, comprising:
an interior chamber defined by a bottom surface surrounded by a wall with top portion of the wall diverging parallel the bottom surface to form a flange;
the bottom surface includes an opening with an alignment and engagement edge;
the flange is for coupling the mounting brace with an actuator, and includes an alignment edge for indexing a coupling relationship with actuator;
the bottom surface opening receiving a valve housing commensurate with alignment and engagement edge to prevent the valve housing from rotation during operation, and allow for easy installation for one of normally open or normally closed operational modes of the valve mechanism.

41. The mounting brace as set forth in claim 40, wherein:
the flange includes a first set of apertures for coupling the mounting brace with the actuator; and
the bottom surface includes a second set of apertures for coupling the mounting brace with an external fluid circuit that includes the valve housing.

42. The mounting brace as set forth in claim 41, wherein:
the second set of apertures of the bottom surface of the mounting brace are positioned near the wall and away from the opening, allowing the remaining bottom surface near the edge of the opening to rest against a top of a flange of the valve housing to hold down, retain, and maintain the position of the valve housing.

43. A flow control system, comprising:
a valve system; and
an electrical actuator associated with the valve system by a mounting brace.

44. The flow control system as set forth in claim 43, wherein:
the mounting brace houses detachably engaging, interlocking interfaces of the valve system and the electrical actuator, while detachably securing the electrical actuator with the valve system.

45. The flow control system as set forth in claim 44, wherein:
the valve system includes a valve assembly associated with an external fluid circuit.

46. The flow control system as set forth in claim 45, wherein:
the mounting brace and the valve assembly have interlocking peripheries.

47. The flow control system as set forth in claim 45, wherein:
the mounting brace is detachably secured with the electrical actuator and the external fluid circuit.
